(19) United States
(12) Patent Application Publication
(10) Pub. No.: US 2006/0117835 A1
(43) Pub. Date: Jun. 8, 2006

(54) Sprinkler replacement methods

(75) Inventor: Ching-Huei Yen, Taipei County (TW)

Correspondence Address: BIRCH STEWART KOLASCH & BIRCH, PO BOX 747, FALLS CHURCH, VA, 22040-0747, US

(73) Assignee: TAIWAN SEMICONDUCTOR MANUFACTURING CO., LTD.

(21) Appl. No.: 11/002,213

(22) Filed: Dec. 3, 2004

(51) Int. Cl. G01M 3/02

(52) U.S. Cl. 73/37; 73/168

(57) ABSTRACT

A sprinkler replacement method for a fire sprinkler piping system with a first pipe, a second pipe, a remote test pipe, a first drain gate, a second drain gate, a connection pipe, and a sprinkler. The method includes the steps of opening the first and second drain gates to drain water from the first, second, and remote test pipes by gravity, connecting an air-water separation device to the first drain gate, connecting a vacuum device to the air-water separation device, closing the second drain gate to enclose the fire sprinkler piping system, evacuating the air-water separation device and fire sprinkler piping system by means of the vacuum device to provide a predetermined negative air pressure therein, removing the sprinkler, wherein water in the connection pipe flows into the air-water separation device by atmospheric pressure, and connecting another sprinkler to the connection pipe.

### BACKGROUND

The invention relates to sprinkler replacement methods, and in particular to sprinkler replacement methods providing fast and safe sprinkler replacement.

Water often remains in the piping system when replacing fire sprinklers. When the sprinklers, especially pendent sprinklers in a clean room, are not carefully replaced, the water remaining in the piping system may leak, causing damage to process tools, spreading foul odors, and increasing humidity therein.

Referring to FIG. 1, a fire sprinkler piping system 1 in a clean room comprises a first pipe 11, a second pipe 12, and a remote test pipe 13. The first pipe 11 is connected to one end of the second pipe 12, and the remote test pipe 13 is connected to the other end of the second pipe 12. An alarm check gate 14 is connected to the first pipe 11. An intake gate 15 is disposed below the alarm check gate 14 and connected to the first pipe 11. The alarm check gate 14 is connected to a drain pipe 16. A first drain gate 17 is connected to the drain pipe 16. A second drain gate 18 and a remote pressure gauge 19 are connected to the remote test pipe 13. The remote pressure gauge 19 is disposed above the second drain gate 18, detecting the water pressure in the remote test pipe 13. A plurality of sprinklers 20 are connected to the second pipe 12 by a plurality of connection pipes 21, respectively. Additionally, process tools (not shown) can be disposed under the sprinklers 20.

Operation of the fire sprinkler piping system 1 is described as follows. When the intake gate 15 opens, external water can flow into the fire sprinkler piping system 1 via the first pipe 11. At this point, the first drain gate 17 and second drain gate 18 are closed. When the temperature in the clean room exceeds or attains a predetermined value, the sprinklers 20 automatically spray water into the clean room.

When the sprinklers 20 are replaced, the intake gate 15 must be closed. The first drain gate 17 and second drain gate 18 are then opened, such that water in the first pipe 11, second pipe 12, and remote test pipe 13 is drained out of the fire sprinkler piping system 1 via the first drain gate 17 and second drain gate 18 by gravity. Nevertheless, since the connection pipes 21 are below the horizontal second pipe 12, water remaining in the connection pipes 21 cannot be drained by gravity. If the sprinklers 20 are directly removed, the water remaining in the connection pipes 21 flows into the clean room.

Thus, some protective measures are required when the sprinklers 20 are sequentially removed. The process tools under the sprinklers 20 must be covered with water-resistant PVC curtains, and anti-static PVC curtains must enclose the sprinklers 20 to isolate potential particles. Buckets, funnels, and tubes must be disposed under a target sprinkler 20 to receive the water remaining in the connection pipe 21 when removed.

Accordingly, the aforementioned sprinkler removal or replacement method has many drawbacks. At least three operators are required during removal or replacement of the sprinklers 20. Specifically, one operator removes or replaces the sprinklers 20 while the others hold the buckets, funnels, and tubes and replace the buckets. Accordingly, manpower for removal or replacement of the sprinklers 20 cannot be reduced. Further, foul odors spread when the water remaining in the connection pipes 21 flows out, causing olfactory discomfort. Further, clean room manufacturing processes must be stopped due to the spread of foul odors. Moreover, additional time is required to allow the water remaining in the connection pipes 21 to flow out by gravity. Replacement of each sprinkler 20 requires at least ten minutes. Thus, an excessive time span or many operators must be required when all the sprinklers 20 in the fire sprinkler piping system 1 (in the clean room) are replaced.

The piping of the fire sprinkler piping system 1 is conventionally examined by reviewing design drawings thereof (visual confirmation). Inaccurate judgment may occur when hidden piping exists or the piping is complex. Specifically, different sprinklers may belong to different fire sprinkler piping systems. If a sprinkler in use and with a water pressure is removed, the water in the fire sprinkler piping system will immediately gush out, causing serious damage to the process tools in the clean room.

### SUMMARY

Methods for replacing sprinklers in a fire sprinkler piping system are provided. A fire sprinkler piping system comprises a first pipe, a second pipe, a remote test pipe, a first drain gate, a second drain gate, at least one connection pipe, and at least one sprinkler. The first pipe is connected to one end of the second pipe, and the remote test pipe is connected to the other end of the second pipe. The first drain gate is connected to the first pipe. The second drain gate is connected to the remote test pipe. One end of the connection pipe is connected to the second pipe, and the other end of the connection pipe is connected to the sprinkler. An exemplary embodiment of a method for replacing sprinkles in the fire sprinkler piping system comprises the steps of: opening the first and second drain gates to drain water from the first, second, and remote test pipes by gravity; connecting an air-water separation device to the first drain gate; connecting a vacuum device to the air-water separation device; closing the second drain gate to enclose the fire sprinkler piping system; evacuating the air-water separation device and fire sprinkler piping system by means of the vacuum device to provide a predetermined negative air pressure therein; removing the sprinkler, wherein water in the connection pipe flows into the air-water separation device via the second and first pipes and first drain gate by atmospheric pressure; connecting another sprinkler to the connection pipe.

Some embodiments of a sprinkler replacement method comprise a step of, prior to connecting another sprinkler to the connection pipe, halting evacuation of the air-water separation device and fire sprinkler piping system by means of the vacuum device.

Some embodiments of a sprinkler replacement method comprise a step of, after connecting another sprinkler to the connection pipe, evacuating the air-water separation device and fire sprinkler piping system by means of the vacuum device to detect whether or not the predetermined negative air pressure is provided therein and whether or not the sprinkler is correctly connected to the connection pipe.

Some embodiments of an air-water separation device comprise a negative pressure gauge to detect the negative air pressure inside the air-water separation device and fire sprinkler piping system.

Some embodiments of an air-water separation device comprise a first air-water separation bucket, a second air-water separation bucket, and an automatic controller. The first and second air-water separation buckets are connected to the first drain gate and vacuum device. The automatic controller is electrically connected to the first and second air-water separation buckets to selectively flow the water in the connection pipe into the first or second air-water separation bucket.

Some embodiments of a first air-water separation bucket comprise a first control valve, a second control valve, and a first water-level sensor, and an embodiment of a second air-water separation bucket further comprises a third control valve, a fourth control valve, and a second water-level sensor. The first and third control valves are connected to the first drain gate and electrically connected to the automatic controller. The second and fourth control valves are connected to the vacuum device and electrically connected to the automatic controller. The first and second water-level sensors are electrically connected to the automatic controller. The automatic controller controls the first and second control valves according to signals from the first water-level sensor. The automatic controller controls the third and fourth control valves according to the signals from the second water-level sensor.

Some embodiments of a first air-water separation bucket comprise a fifth control valve electrically connected to the automatic controller, and an embodiment of a second air-water separation bucket further comprises a sixth control valve electrically connected to the automatic controller. The automatic controller opens the fifth control valve to drain water from the first air-water separation bucket according to the signals from the first water-level sensor. The automatic controller opens the sixth control valve to drain water from the second air-water separation bucket according to the signals from the second water-level sensor.

Some embodiments of the first, second, third, fourth, fifth, and sixth control valves comprise electromagnetic valves.

An exemplary embodiment provides a method for detection of a first fire sprinkler piping system and a second fire sprinkler piping system. The first fire sprinkler piping system comprises a first pipe, a second pipe, a remote test pipe, a first drain gate, and a second drain gate. The first pipe is connected to one end of the second pipe, and the remote test pipe is connected to the other end of the second pipe. The first drain gate is connected to the first pipe. The second drain gate is connected to the remote test pipe. The method comprises the steps of: opening the first and second drain gates to drain water in the first, second, and remote test pipes from the first fire sprinkler piping system by gravity, connecting a sonic wave detection device to the remote test pipe; tapping a sprinkler disposed in the first or second fire sprinkler piping system to generate a tapping sound; receiving the tapping sound using the sonic wave detection device to determine whether the sprinkler is disposed in the first fire sprinkler piping system or in the second fire sprinkler piping system.

Some embodiments of a method for detection of a first fire sprinkler piping system and a second fire sprinkler piping system comprise a step of, after connecting a sonic wave detection device to the remote test pipe, closing the first and second drain gates to enclose the first fire sprinkler piping system to enhance reception of the tapping sound.

Some embodiments of a sonic wave detection device comprise a sonic wave sensor and a speaker. The sonic wave sensor is disposed in the remote test pipe and electrically connected to the speaker.

Some embodiments of a sonic wave detection device comprise an amplifier electrically connected between the sonic wave sensor and the speaker.

Some embodiments of a sonic wave sensor comprise a microphone.

An exemplary embodiment provides a sonic wave detection device for detection of a fire sprinkler piping system comprising a remote test pipe. The sonic wave detection device comprises a sonic wave sensor and a speaker. The sonic wave sensor is disposed in the remote test pipe, receiving sounds transmitted in the fire sprinkler piping system. The speaker is electrically connected to the sonic wave sensor, playing the sounds received by the sonic wave sensor.

### DESCRIPTION OF THE DRAWINGS

The invention can be more fully understood by reading the subsequent detailed description and examples with references made to the accompanying drawings, wherein:

FIG. 1 is a schematic plan view of a fire sprinkler piping system;

FIG. 2 is a schematic plan view of a fire sprinkler piping system employing an embodiment of the sprinkler replacement method;

FIG. 3 is another schematic plan view of a fire sprinkler piping system employing an embodiment of the sprinkler replacement method;

FIG. 4 schematically depicts the inner structure of an air-water separation device according to FIG. 3; and

FIG. 5 is a schematic plan view of a fire sprinkler piping system with the sonic wave detection device of an embodiment.

### DETAILED DESCRIPTION

The sprinkler replacement method in some embodiments of the invention employs the Pascal's principle and the theoretical value of Torricelli tube experiment. In the Torricelli tube experiment, 1 atm (kg/cm²) air can produce a mercury column of 0.76 m or a water column of 10.336 m. Pascal's principle recites that the air pressure values in every position in a closed piping (system) are same.

### First Embodiment

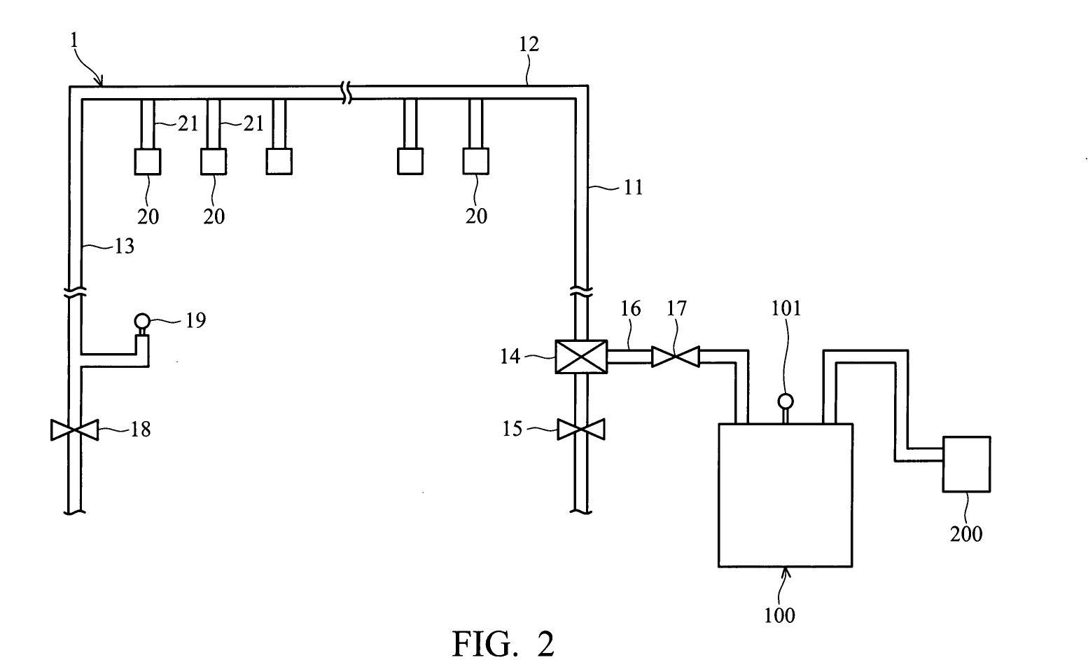

Referring to FIG. 2, when the sprinklers 20 are replaced, the intake gate 15 must be closed. The first drain gate 17 and second drain gate 18 are then opened, such that water in the first pipe 11, second pipe 12, and remote test pipe 13 is drained from the fire sprinkler piping system 1 via the first drain gate 17 and second drain gate 18 by gravity. An air-water separation device 100 is connected to the first drain gate 17. The air-water separation device 100, in this embodiment, can be a closed bucket. A negative pressure gauge 101 is connected to the air-water separation device 100. A vacuum device 200 is then connected to the air-water separation device 100. The vacuum device 200 is not limited to a specific type of machine. For example, the vacuum device 200 may be a household vacuum cleaner. The second drain gate 18 connected to the remote test pipe 13 is closed, thereby enclosing the fire sprinkler piping system 1. The air-water separation device 100 and fire sprinkler piping system 1 are evacuated by the vacuum device 200. After the air-water separation device 100 and fire sprinkler piping system 1 are evacuated over a span of time, a predetermined negative air pressure, the air pressure less than the atmospheric pressure, is provided therein. The predetermined negative air pressure can be read by observing the negative pressure gauge 101 connected to the air-water separation device 100.

Specifically, different vacuum devices can generate different negative air pressure values in the air-water separation device 100 and fire sprinkler piping system 1. For example, a vacuum cleaner with an operating power of 850 (2000) W may generate a negative air pressure of −0.16 (−0.22) kg/cm² in the air-water separation device 100 and fire sprinkler piping system 1. The negative air pressure of −0.16 (−0.22) kg/cm² can theoretically draw a water column of 1.65(2.27) m. Accordingly, the operating power of the vacuum device 200 can be determined according to the height of the connection pipe 21 of the fire sprinkler piping system 1. In this embodiment, the predetermined negative air pressure provided by the vacuum device 200 is hypothetically capable of drawing the water column to the same height as the connection pipe 21.

One (or more) of the sprinklers 20 can then be removed. At this point, the water remaining in the corresponding connection pipe 21 flows rapidly into the air-water separation device 100 via the second pipe 12, first pipe 11, and first drain gate 17 by atmospheric pressure thereunder. The air is evacuated to the environment by the vacuum device 200. Operation of the vacuum device 200 can then be halted, and another sprinkler 20 can be connected to the connection pipe 21. At this point, the replacement of the sprinkler 20 is complete.

Moreover, after the sprinkler 20 is replaced, the air-water separation device 100 and fire sprinkler piping system 1 can again be evacuated by the vacuum device 200. By observing the negative pressure gauge 101, whether or not the predetermined negative air pressure is again provided inside the air-water separation device 100 and fire sprinkler piping system 1 can be detected, and whether or not the sprinkler 20 is correctly connected to the connection pipe 21 can be confirmed.

Similarly, other sprinklers 20 of the fire sprinkler piping system 1 can be sequentially replaced using the aforementioned steps.

### Second Embodiment

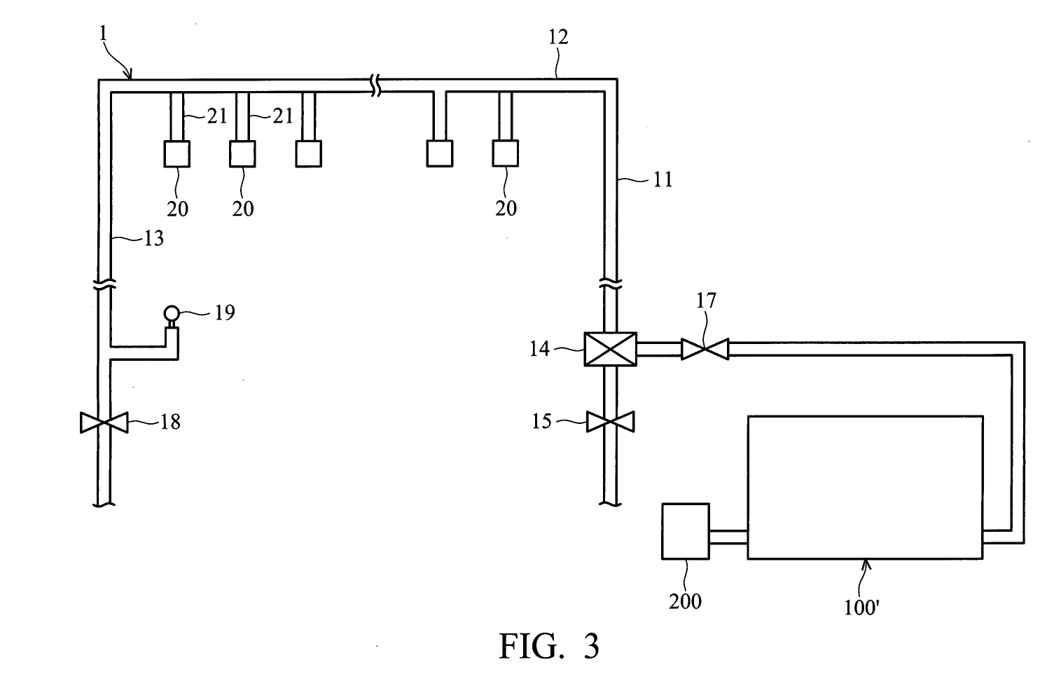

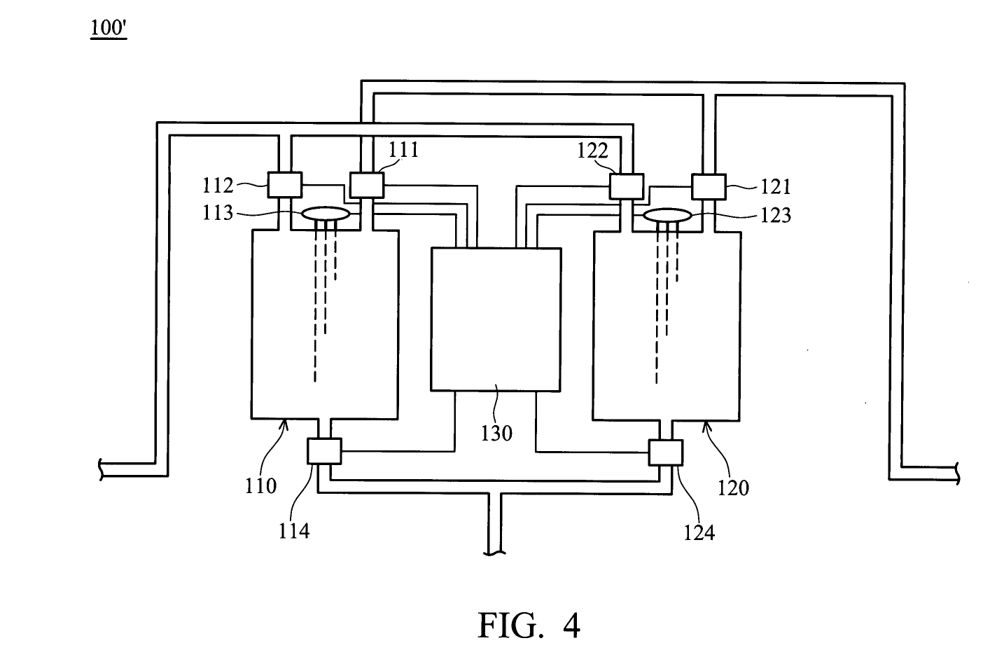

Referring to FIG. 3 and FIG. 4, the difference between this embodiment and the first embodiment is that this embodiment employs an automatic air-water separation device 100′.

As shown in FIG. 4, the air-water separation device 100′ comprises a first air-water separation bucket 110, a second air-water separation bucket 120, and an automatic controller 130. The first air-water separation bucket 110 further comprises a first control valve 111, a second control valve 112, a first water-level sensor 113, and a fifth control valve 114. The second air-water separation bucket 120 further comprises a third control valve 121, a fourth control valve 122, a second water-level sensor 123, and a sixth control valve 124.

The first air-water separation bucket 110 and second air-water separation bucket 120 are connected to the first drain gate 17 by means of the first control valve 111 and third control valve 121, respectively. Additionally, the first air-water separation bucket 110 and second air-water separation bucket 120 are connected to the vacuum device 200 by means of the second control valve 112 and fourth control valve 122, respectively. The fifth control valve 114 is connected to the bottom of the first air-water separation bucket 110 while the sixth control valve 124 is connected to that of the second air-water separation bucket 120. The first control valve 111, second control valve 112, first water-level sensor 113, fifth control valve 114, third control valve 121, fourth control valve 122, second water-level sensor 123, and sixth control valve 124 are electrically connected to the automatic controller 130.

The following description is directed to operation of the air-water separation device 100′.

When the first air-water separation bucket 110 is used to receive the remaining water from the connection pipes 21, the automatic controller 130 outputs signals to open the first control valve 111 and second control valve 112 and to close the fifth control valve 114, third control valve 121, and fourth control valve 122. At this point, the vacuum device 200 provides the predetermined negative air pressure inside the air-water separation device 100′ and fire sprinkler piping system 1. When one (or more) of the sprinklers 20 is removed, the remaining water in the corresponding connection pipe 21 flows quickly into the first air-water separation bucket 110 via the second pipe 12, first pipe 11, and first drain gate 17. Specifically, the aforementioned removal of the sprinkler 20 can be repeated until the water in the first air-water separation bucket 110 reaches a predetermined level. Accordingly, the first water-level sensor 113 outputs a signal to the automatic controller 130 when the water in the first air-water separation bucket 110 reaches the predetermined level. The automatic controller 130 then outputs signals to close the first control valve 111, second control valve 112, and sixth control valve 124 and to open the fifth control valve 114, third control valve 121, and fourth control valve 122. At this point, the water in the first air-water separation bucket 110 can be drained from the air-water separation device 100′ via the fifth control valve 114. When the remaining sprinklers 20 are removed, the remaining water in the corresponding connection pipes 21 flows quickly into the second air-water separation bucket 120 via the second pipe 12, first pipe 11, and first drain gate 17. Similarly, when the water in the second air-water separation bucket 120 reaches a predetermined level, the second water-level sensor 123 outputs a signal to the automatic controller 130 and the automatic controller 130 outputs signals to open first control valve 111, second control valve 112, and sixth control valve 124 and to close the fifth control valve 114, third control valve 121, and fourth control valve 122. At this point, the water in the second air-water separation bucket 120 can be drained from the air-water separation device 100′ via the sixth control valve 124. Accordingly, the air-water separation device 100′ can achieve automatic drain by alternate operation of the first air-water separation bucket 110 and second air-water separation bucket 120, thus reducing operational manpower.

Additionally, the first control valve 111, second control valve 112, third control valve 121, fourth control valve 122, fifth control valve 114, and sixth control valve 124 may be electromagnetic valves.

Accordingly, since the water remaining in the connection pipes of the fire sprinkler piping system is drained in physical manner, only one or two operators are required during the replacement of the sprinklers thereof. Thus, the operational manpower during the replacement of the sprinklers may be reduced. Moreover, since the water remaining in the connection pipes can be quickly drained, time for replacement of the sprinklers may be reduced. Specifically, since the water remaining in the connection pipes does not directly flow into the clean room, water sprinkling, increase of humidity and particles, and foul odors are not generated in the clean room. Buckets, funnels, and tubes are not required during the replacement of the sprinklers using the aforementioned sprinkler replacement method. Additionally, the process tools may not have to be covered with water-resistant PVC curtains and the sprinklers may not have to be enclosed by the anti-static PVC curtains. Thus, operational complexity during the replacement of the sprinklers may potentially be reduced.

### Third Embodiment

A sound wave or sound is generated by vibration of objects and is transmitted by means of mediums.

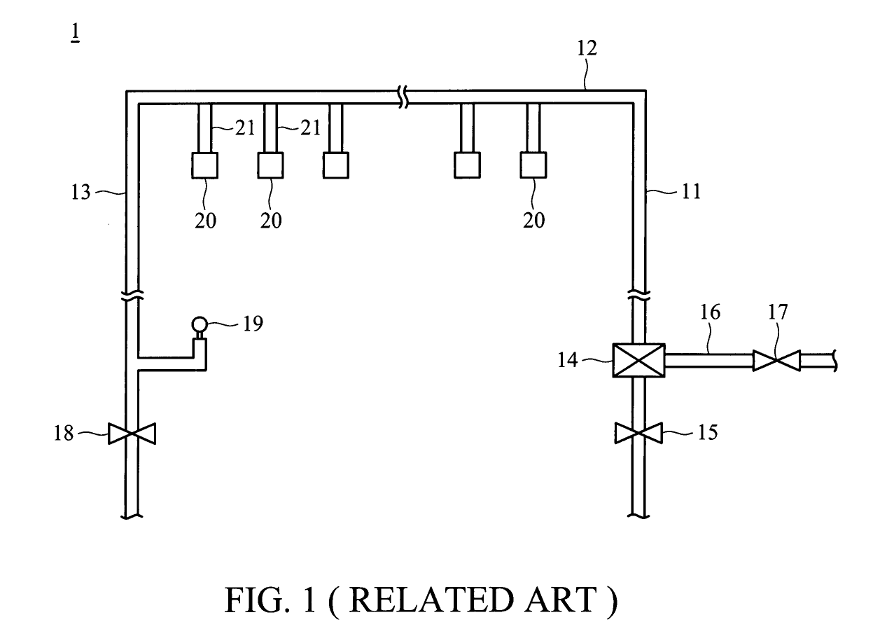

As shown in FIG. 1, when the first drain gate 17 and second drain gate 18 are opened, the water in the first pipe 11, second pipe 12, and remote test pipe 13 is drained from the fire sprinkler piping system 1 by gravity. The replacement of the sprinklers 20 can then be performed. Nevertheless, a plurality of independent fire sprinkler piping systems may exist in the clean room. This embodiment employs a sonic wave detection device to confirm a target sprinkler 20 belonging to the fire sprinkler piping system 1.

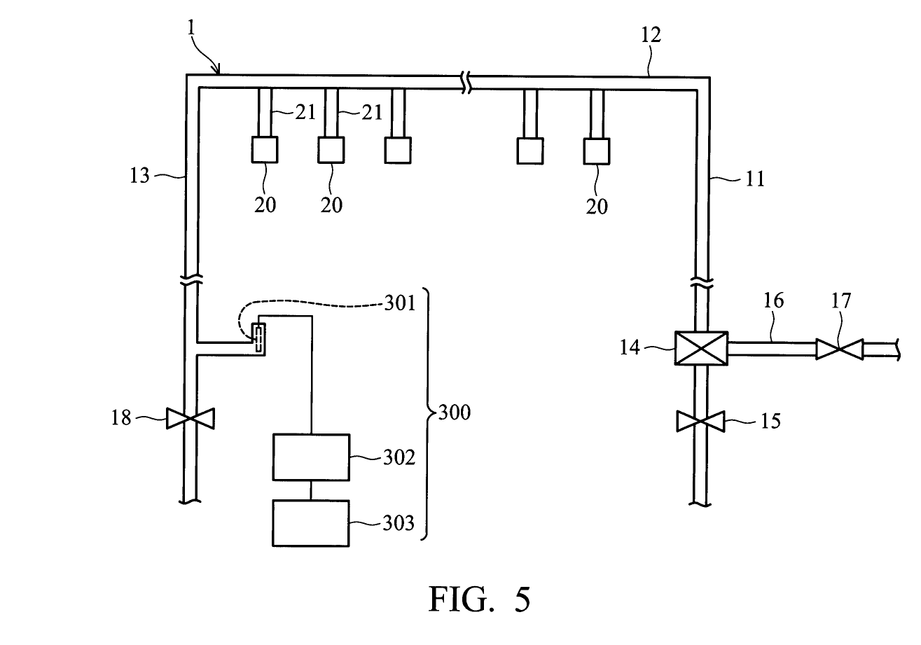

Referring to FIG. 5, the remote pressure gauge 19 connected to the remote test pipe 13 is removed and replaced by a sonic wave detection device 300. Namely, the sonic wave detection device 300 is connected to the remote test pipe 13. The sonic wave detection device 300 comprises a microphone (sonic wave sensor) 301, an amplifier 302, and a speaker 303. The microphone 301 is disposed in the remote test pipe 13 and sealed therewith by glue or other adhesive materials. A signal cable of the microphone 301 extends out of the remote test pipe 13 and is electrically connected to the amplifier 302. The amplifier 302 is electrically connected to the speaker 303.

The first drain gate 17 and second drain gate 18 are closed to enclose the fire sprinkler piping system 1. A target sprinkler is then tapped to generate a tapping sound (wave). When the target sprinkler belongs to the enclosed fire sprinkler piping system 1, the tapping sound (wave) is transmitted by means of a medium (air or water) therein to the microphone 301 and is received thereby. The tapping sound (wave) is then amplified by the amplifier 302 and is played by the speaker 303. At this point, the target sprinkler belonging to the fire sprinkler piping system 1 is confirmed and can be removed.

Conversely, when the target sprinkler does not belong to the enclosed fire sprinkler piping system 1, no tapping sound (wave) is emitted by the speaker 303 after the target sprinkler is tapped. Namely, the target sprinkler belongs to another fire sprinkler piping system 1 with water pressure or in use. Specifically, the tapping sound (wave) can only be transmitted in an enclosed piping and cannot simultaneously be transmitted in two enclosed piping. Accordingly, to prevent water damage in the clean room, the target sprinkler cannot be removed.

Accordingly, confirmation of the target sprinkler can be effectively and safely performed by means of the aforementioned detection method employing the sonic wave detection device 300.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sprinkler replacement method for a fire sprinkler piping system with a first pipe, a second pipe, a remote test pipe, a first drain gate, a second drain gate, at least one connection pipe, and at least one sprinkler, wherein the first pipe is connected to one end of the second pipe, the remote test pipe is connected to the other end of the second pipe, the first drain gate is connected to the first pipe, the second drain gate is connected to the remote test pipe, one end of the connection pipe is connected to the second pipe, and the other end of the connection pipe is connected to the sprinkler, the method comprising:
opening the first and second drain gates to drain water from the first, second, and remote test pipes by gravity;
connecting an air-water separation device to the first drain gate;
connecting a vacuum device to the air-water separation device;
closing the second drain gate to enclose the fire sprinkler piping system;
evacuating the air-water separation device and fire sprinkler piping system by means of the vacuum device to provide a predetermined negative air pressure therein;
removing the sprinkler, wherein water in the connection pipe flows into the air-water separation device via the second and first pipes and first drain gate by atmospheric pressure; and
connecting another sprinkler to the connection pipe.

2. The sprinkler replacement method as claimed in claim 1, further comprising a step, prior to connecting another sprinkler to the connection pipe, of:
halting evacuation of the air-water separation device and fire sprinkler piping system by means of the vacuum device.

3. The sprinkler replacement method as claimed in claim 2, further comprising a step, after connecting another sprinkler to the connection pipe, of:
evacuating the air-water separation device and fire sprinkler piping system by means of the vacuum device to detect whether or not the predetermined negative air pressure is provided therein and whether or not the sprinkler is correctly connected to the connection pipe.

4. The sprinkler replacement method as claimed in claim 1, wherein the air-water separation device further comprises a negative pressure gauge to detect the negative air pressure inside the air-water separation device and fire sprinkler piping system.

5. The sprinkler replacement method as claimed in claim 1, wherein the air-water separation device further comprises a first air-water separation bucket, a second air-water separation bucket, and an automatic controller, the first and second air-water separation buckets are connected to the first drain gate and vacuum device, and the automatic controller is electrically connected to the first and second air-water separation buckets to selectively direct the flow of water in the connection pipe into the first or second air-water separation bucket.

6. The sprinkler replacement method as claimed in claim 5, wherein the first air-water separation bucket further comprises a first control valve, a second control valve, and a first water-level sensor, the second air-water separation bucket further comprises a third control valve, a fourth control valve, and a second water-level sensor, the first and third control valves are connected to the first drain gate and electrically connected to the automatic controller, the second and fourth control valves are connected to the vacuum device and electrically connected to the automatic controller, the first and second water-level sensors are electrically connected to the automatic controller, the automatic controller controls the first and second control valves according to signals from the first water-level sensor, and the automatic controller controls the third and fourth control valves according to the signals from the second water-level sensor.

7. The sprinkler replacement method as claimed in claim 6, wherein the first air-water separation bucket further comprises a fifth control valve electrically connected to the automatic controller, the second air-water separation bucket further comprises a sixth control valve electrically connected to the automatic controller, the automatic controller opens the fifth control valve to drain water from the first air-water separation bucket according to the signals from the first water-level sensor, and the automatic controller opens the sixth control valve to drain water from the second air-water separation bucket according to the signals from the second water-level sensor.

8. The sprinkler replacement method as claimed in claim 7, wherein the first, second, third, fourth, fifth, and sixth control valves comprise electromagnetic valves.

9. A method for detection of a first pipe and a second pipe, comprising:
connecting a sonic wave detection device to the first pipe;
tapping a target portion on the first or second pipe to generate a tapping sound; and
receiving the tapping sound using the sonic wave detection device to determine whether the target portion is on the first pipe or on the second pipe.

10. The method as claimed in claim 9, further comprising a step, after connecting a sonic wave detection device to the first pipe, of:
enclosing the first pipe to enhance the effect of receiving the tapping sound using the sonic wave detection device.

11. The method as claimed in claim 9, wherein the sonic wave detection device comprises a sonic wave sensor and a speaker, and the sonic wave sensor is disposed in the first pipe and is electrically connected to the speaker.

12. The method as claimed in claim 11, wherein the sonic wave detection device further comprises an amplifier electrically connected between the sonic wave sensor and the speaker.

13. The method as claimed in claim 11, wherein the sonic wave sensor comprises a microphone.

14. A method for detection of a first fire sprinkler piping system and a second fire sprinkler piping system, wherein the first fire sprinkler piping system comprises a first pipe, a second pipe, a remote test pipe, a first drain gate, and a second drain gate, the first pipe is connected to one end of the second pipe, the remote test pipe is connected to the other end of the second pipe, the first drain gate is connected to the first pipe, the second drain gate is connected to the remote test pipe, the method comprising:
opening the first and second drain gates to drain water in the first, second, and remote test pipes from the first fire sprinkler piping system by gravity;
connecting a sonic wave detection device to the remote test pipe;
tapping a sprinkler disposed in the first or second fire sprinkler piping system to generate a tapping sound; and
receiving the tapping sound using the sonic wave detection device to determine whether the sprinkler is disposed in the first fire sprinkler piping system or in the second fire sprinkler piping system.

15. The method as claimed in claim 14, further comprising a step, after connecting a sonic wave detection device to the remote test pipe, of:
closing the first and second drain gates to enclose the first fire sprinkler piping system, enhancing the effect of receiving the tapping sound using the sonic wave detection device.

16. The method as claimed in claim 14, wherein the sonic wave detection device comprises a sonic wave sensor and a speaker, and the sonic wave sensor is disposed in the remote test pipe and electrically connected to the speaker.

17. The method as claimed in claim 16, wherein the sonic wave detection device further comprises an amplifier electrically connected between the sonic wave sensor and the speaker.

18. The method as claimed in claim 16, wherein the sonic wave sensor comprises a microphone.

19. A sonic wave detection device for detection of a fire sprinkler piping system comprising a remote test pipe, comprising:
a sonic wave sensor disposed in the remote test pipe, receiving a sound transmitted in the fire sprinkler piping system; and
a speaker electrically connected to the sonic wave sensor, emitting the sound received by the sonic wave sensor.

20. The sonic wave detection device as claimed in claim 19, further comprising an amplifier electrically connected between the sonic wave sensor and the speaker to amplify the sound received by the sonic wave sensor.

21. The sonic wave detection device as claimed in claim 19, wherein the sonic wave sensor comprises a microphone.
